(19) United States
(12) Patent Application Publication
(10) Pub. No.: US 2024/0344815 A1
(43) Pub. Date: Oct. 17, 2024

(54) FIRE EXTINGUISHING MORTAR SHELL

(71) Applicant: Thomas Schmidt, Laurinburg, NC (US)

(72) Inventor: Thomas Schmidt, Laurinburg, NC (US)

(21) Appl. No.: 18/135,175

(22) Filed: Apr. 16, 2023

(51) Int. Cl. F42B 12/46; A62C 99/00

(52) U.S. Cl. CPC F42B 12/46; A62C 99/00

(57) ABSTRACT

A fire extinguishing mortar shell, including a main body to store at least one compound therein, a fire retardant compound disposed within the main body to eliminate a fire in response to contact with the fire, a multi-option fuse disposed on at least a portion of the main body to send a detonation signal therefrom in response to detecting the fire and a position of the main body with respect to a target surface where the fire is located, and at least one propellant charge disposed on at least a portion of the main body to detonate the main body to release the at least one fire retardant compound in response to receiving the detonation signal from the multi-option fuse.

### BACKGROUND

### 1. Field

The present general inventive concept relates generally to fire extinguishers, and particularly, to a fire extinguishing mortar shell.

### 2. Description of the Related Art

Climate change has exacerbated existing seasonal weather patterns, making wildfires and brushfires more common around the world. These types of fires are difficult to stop due to location of the wildfire and limited accessibility based on terrain.

Typically, a fire retardant is sprayed over the wildfire using aircraft and other vehicles. However, the use of aircraft and other vehicles can be a slow process that allows the fire to spread in untreated areas.

Therefore, there is a need for a fire extinguishing mortar shell that can be used to target a wildfire and release the fire retardant over a large area in a short period of time.

### SUMMARY

The present general inventive concept provides a fire extinguishing mortar shell.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a fire extinguishing mortar shell, including a main body to store at least one compound therein, a fire retardant compound disposed within the main body to eliminate a fire in response to contact with the fire, a multi-option fuse disposed on at least a portion of the main body to send a detonation signal therefrom in response to detecting the fire and a position of the main body with respect to a target surface where the fire is located, and at least one propellant charge disposed on at least a portion of the main body to detonate the main body to release the at least one fire retardant compound in response to receiving the detonation signal from the multi-option fuse.

The fire retardant compound may be at least one of huntite, hydromagnesite, aluminum hydroxide, and magnesium hydroxide.

The multi-option fuse may monitor at least one of a position of the main body, an altitude of the main body, a temperature level of a surrounding environment of the main body, and a terrain of the surrounding environment.

The fire extinguishing mortar shell may further include a fuse selector movably disposed on at least a portion of the main body to select a fuse setting for the multi-option fuse.

The fuse selector may select at least one of a type of a mortar shell, a time period for detonation, a time delay prior to detonation, and a time delay to detonation after reaching the target surface.

The fire extinguishing mortar shell may further include an ignition unit disposed on at least a portion of the main body to ignite the at least one propellant charge.

The fire extinguishing mortar shell may further include a plurality of fins disposed on at least a portion of the main body to stabilize movement of the main body during flight.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side perspective view of a fire extinguishing mortar shell, according to an exemplary embodiment of the present general inventive concept;

FIG. 2 illustrates a side perspective view of a fire extinguishing mortar shell, according to another exemplary embodiment of the present general inventive concept; and

FIG. 3 illustrates a side perspective view of a fire extinguishing mortar shell, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Fire Extinguishing Mortar Shell 100
Main Body 110
Fire Retardant Payload Container 111
Tail Cone 112
Multi-Option Fuse 120
Fuse Selector 130
Propellant Charges 140
Ignition Unit 150
Obturating Ring 180
Fire Extinguishing Mortar Shell 200
Main Body 210
Fire Retardant Payload Container 211
Tail Cone 212
Multi-Option Fuse 220
Fuse Selector 230
Propellant Charges 240
Ignition Unit 250
Fins 260
Primer Plug 270
Obturating Ring 280
Fire Extinguishing Mortar Shell 300
Main Body 310
Fire Retardant Payload Container 311
Tail Cone 312
Multi-Option Fuse 320
Fuse Selector 330
Propellant Charges 340
Ignition Unit 350
Fins 360
Primer Plug 370
Obturating Ring 380

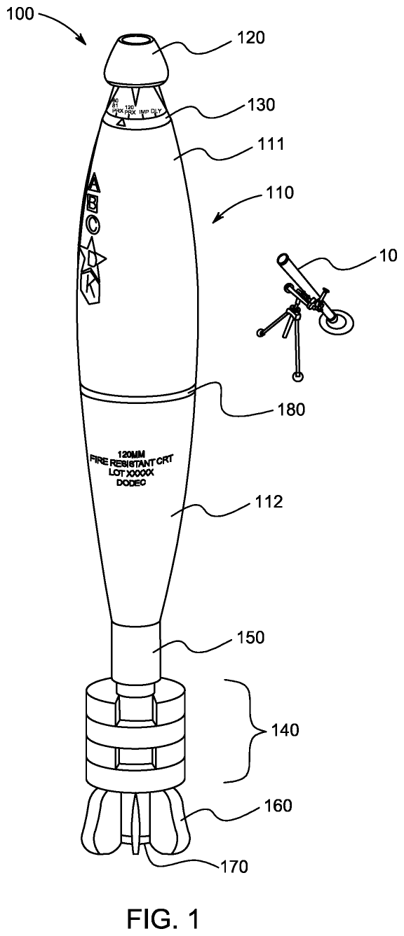

FIG. 1 illustrates a side perspective view of a fire extinguishing mortar shell 100, according to an exemplary embodiment of the present general inventive concept.

The fire extinguishing mortar shell 100 may be constructed from at least one of metal, plastic, glass, and rubber, etc., but is not limited thereto.

The fire extinguishing mortar shell 100 may include a main body 110, a multi-option fuse 120, a fuse selector 130, a plurality of propellant charges 140, an ignition unit 150, a plurality of fins 160, a primer plug 170, and an obturating ring 180, but is not limited thereto.

Referring to FIG. 1, the main body 110 is illustrated to be an M120 120-millimeter (mm) shell. However, the main body 110 may be any other size and/or shape of mortar shell known to one of ordinary skill in the art, but is not limited thereto.

The main body 110 may include a fire retardant payload container 111 and a tail cone 112, but is not limited thereto.

The fire retardant payload container 111 may store at least one fire retardant compound therein. For example, the fire retardant payload container 111 may store water, chemicals, powder, foam, and/or gel therein. Additionally, the at least one fire retardant compound may be constructed from huntite, hydromagnesite, aluminum hydroxide, and/or magnesium hydroxide. The at least one fire retardant compound may prevent and/or eliminate a fire in response to contact with the fire.

The tail cone 112 may be disposed on at least a portion of the fire retardant payload container 111. The tail cone 112 may store at least one other fire retardant compound therein. For example, the tail cone 112 may store other chemicals to be mixed with the at least one fire retardant compound within the fire retardant payload container 111 in response to detonation and/or collapse of an entirety of a structure of the fire retardant payload container 111 and/or the tail cone 112.

The multi-option fuse 120 may include a processing unit (e.g., a processor, a controller), at least one sensor, a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet, but is not limited thereto.

The multi-option fuse 120 may be disposed on at least a portion of an end of the fire retardant payload container 111. The multi-option fuse 120 may monitor a position of the main body 110, an altitude of the main body 110, a temperature level of a surrounding environment of the main body 110, and/or a terrain of the surrounding environment. More specifically, the multi-option fuse 120 may detect the fire and/or a position of the main body 110 with respect to a surface (e.g., a ground surface, a building, etc.). Additionally, the multi-option fuse 120 may send a detonation signal therefrom in response to detecting the fire and/or the position of the main body 110 with respect to a target surface where the fire is located has been reached.

The fuse selector 130 may be movably (i.e., rotatably) disposed on at least a portion of the fire retardant payload container 111. The fuse selector 130 may move (i.e., rotate) in a first rotational direction (i.e., clockwise) or a second rotational direction (i.e., counterclockwise) in response to an application of force (e.g., pushing, pulling) thereto. The fuse selector 130 may be moved to select a fuse setting for the multi-option fuse 120. For example, the fuse selector 130 may select a type of the mortar shell (e.g., 120-mm), a time period for detonation, a time delay prior to detonation, and/or a time delay to detonation after reaching the target surface and/or the fire.

Each of the plurality of propellant charges 140 may include pyroxyline, but is not limited thereto. Also, the plurality of propellant charges 140 may be any type of propellant charge, such as M219 propelling charges, M204 propelling charges, and/or M230 propelling charges.

The plurality of propellant charges 140 may be disposed on at least a portion of an end of the tail cone 112. The plurality of propellant charges 140 may ignite and/or detonate in response to contacting a firing pin within a rifled barrel 10. The plurality of propellant charges 140 may adjust a trajectory, speed, and/or range of the main body 110 in response to being propelled from the rifled barrel 10. Moreover, a number of the plurality of propellant charges 140 may be adjusted (i.e., added, subtracted) to change the trajectory, the speed, and/or the range during firing.

The ignition unit 150 may include an ignition cartridge, a flash reducer, and a piston, but is not limited thereto. Also, the ignition cartridge of the ignition unit 150 may be any type of ignition cartridge, such as an M752A1 ignition cartridge.

The ignition unit 150 may be disposed at the end of the tail cone 112. The ignition unit 150 may ignite at least one of the plurality of propellant charges 140 in response to contact with the firing pin within the rifled barrel 10. In other words, the ignition unit 150 may facilitate ignition of at least one of the plurality of propellant charges 140. Also, the ignition unit 150 may ignite the plurality of propellant charges 140 to detonate the main body 110 to release the at least one fire retardant compound in response to receiving the detonation signal from the multi-option fuse 120. For example, the piston of the ignition unit 150 may strike at least one of the plurality of propellant charges 140.

The flash reducer of the ignition unit 150 may reduce a flash during propelling of the main body 110 from the rifled barrel 10.

The plurality of fins 160 may be disposed on at least a portion of the end of the tail cone 112 and/or the ignition unit 150. The plurality of fins 160 may extend away from a center of the ignition unit 150. Moreover, the plurality of fins 160 may stabilize movement of the main body 110 to ensure accuracy of the main body 110 during flight.

The primer plug 170 may be disposed at a center of the plurality of fins 160. The primer plug 170 may ignite the ignition unit 150 in response to contact with the firing pin of the rifled barrel 10.

The obturating ring 180 may be disposed between the fire retardant payload container 111 and/or the tail cone 112. The obturating ring 180 may seal a connection between the fire retardant payload container 111 and/or the tail cone 112. Thus, the obturating ring 180 may form a pressurized seal within the main body 110. As such, the obturating ring 112 may prevent the at least one fire retardant compound from leaking. However, the obturating ring 180 may rupture along an axis during detonation to ensure disbursement of the at least one fire retardant compound.

Therefore, the fire extinguishing mortar shell 100 may quickly extinguish a wildfire and/or a brushfire in response to detonating over the fire and resolve fire hazards at federal, state, local, and tribal levels. Also, the fire extinguishing mortar shell 100 may reduce complexity of managing the wildfire and/or the brushfire in difficult terrain.

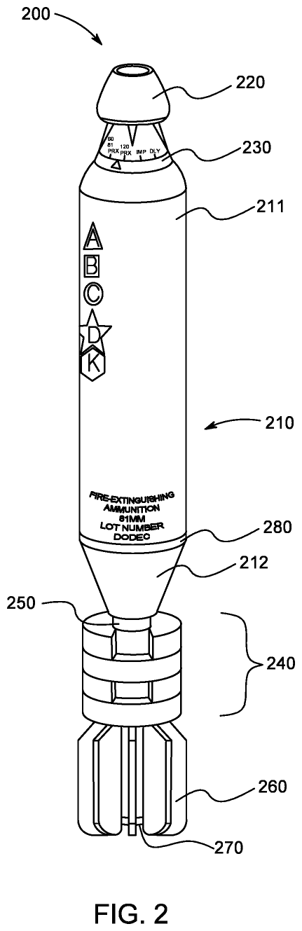

FIG. 2 illustrates a side perspective view of a fire extinguishing mortar shell 200, according to another exemplary embodiment of the present general inventive concept.

The fire extinguishing mortar shell 200 may be constructed from at least one of metal, plastic, glass, and rubber, etc., but is not limited thereto.

The fire extinguishing mortar shell 200 may include a main body 210, a multi-option fuse 220, a fuse selector 230, a plurality of propellant charges 240, an ignition unit 250, a plurality of fins 260, a primer plug 270, and an obturating ring 280, but is not limited thereto.

Referring to FIG. 2, the main body 210 is illustrated to be an M252 81-millimeter (mm) shell. However, the main body 210 may be any other size and/or shape of mortar shell known to one of ordinary skill in the art, but is not limited thereto.

The main body 210 may include a fire retardant payload container 211 and a tail cone 212, but is not limited thereto.

The fire retardant payload container 211 may store at least one fire retardant compound therein. For example, the fire retardant payload container 211 may store water, chemicals, powder, foam, and/or gel therein. Additionally, the at least one fire retardant compound may be constructed from huntite, hydromagnesite, aluminum hydroxide, and/or magnesium hydroxide. The at least one fire retardant compound may prevent and/or eliminate a fire in response to contact with the fire.

The tail cone 212 may be disposed on at least a portion of the fire retardant payload container 211. The tail cone 212 may store at least one other fire retardant compound therein. For example, the tail cone 212 may store other chemicals to be mixed with the at least one fire retardant compound within the fire retardant payload container 211 in response to detonation and/or collapse of an entirety of a structure of the fire retardant payload container 211 and/or the tail cone 212.

The multi-option fuse 220 may include a processing unit (e.g., a processor, a controller), at least one sensor, a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet, but is not limited thereto.

The multi-option fuse 220 may be disposed on at least a portion of an end of the fire retardant payload container 211. The multi-option fuse 220 may monitor a position of the main body 210, an altitude of the main body 210, a temperature level of a surrounding environment of the main body 210, and/or a terrain of the surrounding environment. More specifically, the multi-option fuse 220 may detect the fire and/or a position of the main body 210 with respect to a surface (e.g., a ground surface, a building, etc.). Additionally, the multi-option fuse 220 may send a detonation signal therefrom in response to detecting the fire and/or the position of the main body 210 with respect to a target surface where the fire is located has been reached.

The fuse selector 230 may be movably (i.e., rotatably) disposed on at least a portion of the fire retardant payload container 211. The fuse selector 230 may move (i.e., rotate) in a first rotational direction (i.e., clockwise) or a second rotational direction (i.e., counterclockwise) in response to an application of force (e.g., pushing, pulling) thereto. The fuse selector 230 may be moved to select a fuse setting for the multi-option fuse 220. For example, the fuse selector 230 may select a type of the mortar shell (e.g., 81-mm), a time period for detonation, a time delay prior to detonation, and/or a time delay to detonation after reaching the target surface and/or the fire.

Each of the plurality of propellant charges 240 may include pyroxyline, but is not limited thereto. Also, the plurality of propellant charges 240 may be any type of propellant charge, such as M219 propelling charges, M204 propelling charges, and/or M230 propelling charges.

The plurality of propellant charges 240 may be disposed on at least a portion of an end of the tail cone 212. The plurality of propellant charges 240 may ignite and/or detonate in response to contacting a firing pin within a rifled barrel 10. The plurality of propellant charges 240 may adjust a trajectory, speed, and/or range of the main body 210 in response to being propelled from the rifled barrel 10. Moreover, a number of the plurality of propellant charges 240 may be adjusted (i.e., added, subtracted) to change the trajectory, the speed, and/or the range during firing.

The ignition unit 250 may include an ignition cartridge, a flash reducer, and a piston, but is not limited thereto. Also, the ignition cartridge of the ignition unit 250 may be any type of ignition cartridge, such as an M752A1 ignition cartridge.

The ignition unit 250 may be disposed at the end of the tail cone 212. The ignition unit 250 may ignite at least one of the plurality of propellant charges 240 in response to contact with the firing pin within the rifled barrel 10. In other words, the ignition unit 250 may facilitate ignition of at least one of the plurality of propellant charges 240. Also, the ignition unit 250 may ignite the plurality of propellant charges 240 to detonate the main body 210 to release the at least one fire retardant compound in response to receiving the detonation signal from the multi-option fuse 220. For example, the piston of the ignition unit 250 may strike at least one of the plurality of propellant charges 240.

The flash reducer of the ignition unit 250 may reduce a flash during propelling of the main body 210 from the rifled barrel 10.

The plurality of fins 260 may be disposed on at least a portion of the end of the tail cone 212 and/or the ignition unit 250. The plurality of fins 260 may extend away from a center of the ignition unit 250. Moreover, the plurality of fins 260 may stabilize movement of the main body 210 to ensure accuracy of the main body 210 during flight.

The primer plug 270 may be disposed at a center of the plurality of fins 260. The primer plug 270 may ignite the ignition unit 250 in response to contact with the firing pin of the rifled barrel 10.

The obturating ring 280 may be disposed between the fire retardant payload container 211 and/or the tail cone 212. The obturating ring 280 may seal a connection between the fire retardant payload container 211 and/or the tail cone 212. Thus, the obturating ring 280 may form a pressurized seal within the main body 210. As such, the obturating ring 212 may prevent the at least one fire retardant compound from leaking. However, the obturating ring 280 may rupture along an axis during detonation to ensure disbursement of the at least one fire retardant compound.

Therefore, the fire extinguishing mortar shell 200 may quickly extinguish a wildfire and/or a brushfire in response to detonating over the fire and resolve fire hazards at federal, state, local, and tribal levels. Also, the fire extinguishing mortar shell 200 may reduce complexity of managing the wildfire and/or the brushfire in difficult terrain.

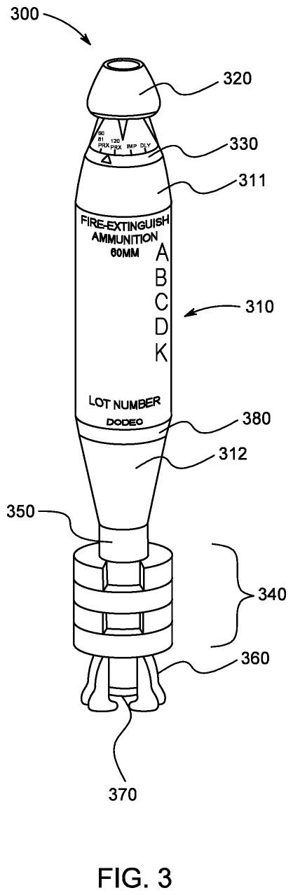

FIG. 3 illustrates a side perspective view of a fire extinguishing mortar shell 300, according to another exemplary embodiment of the present general inventive concept.

The fire extinguishing mortar shell 300 may be constructed from at least one of metal, plastic, glass, and rubber, etc., but is not limited thereto.

The fire extinguishing mortar shell 300 may include a main body 310, a multi-option fuse 320, a fuse selector 330, a plurality of propellant charges 340, an ignition unit 350, a plurality of fins 360, a primer plug 370, and an obturating ring 380, but is not limited thereto.

Referring to FIG. 3, the main body 310 is illustrated to be an M224 60-millimeter (mm) shell. However, the main body 310 may be any other size and/or shape of mortar shell known to one of ordinary skill in the art, but is not limited thereto.

The main body 310 may include a fire retardant payload container 311 and a tail cone 312, but is not limited thereto.

The fire retardant payload container 311 may store at least one fire retardant compound therein. For example, the fire retardant payload container 311 may store water, chemicals, powder, foam, and/or gel therein. Additionally, the at least one fire retardant compound may be constructed from huntite, hydromagnesite, aluminum hydroxide, and/or magnesium hydroxide. The at least one fire retardant compound may prevent and/or eliminate a fire in response to contact with the fire.

The tail cone 312 may be disposed on at least a portion of the fire retardant payload container 311. The tail cone 312 may store at least one other fire retardant compound therein. For example, the tail cone 312 may store other chemicals to be mixed with the at least one fire retardant compound within the fire retardant payload container 311 in response to detonation and/or collapse of an entirety of a structure of the fire retardant payload container 311 and/or the tail cone 312.

The multi-option fuse 320 may include a processing unit (e.g., a processor, a controller), at least one sensor, a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet, but is not limited thereto.

The multi-option fuse 320 may be disposed on at least a portion of an end of the fire retardant payload container 311. The multi-option fuse 320 may monitor a position of the main body 310, an altitude of the main body 310, a temperature level of a surrounding environment of the main body 310, and/or a terrain of the surrounding environment. More specifically, the multi-option fuse 320 may detect the fire and/or a position of the main body 310 with respect to a surface (e.g., a ground surface, a building, etc.). Additionally, the multi-option fuse 320 may send a detonation signal therefrom in response to detecting the fire and/or the position of the main body 310 with respect to a target surface where the fire is located has been reached.

The fuse selector 330 may be movably (i.e., rotatably) disposed on at least a portion of the fire retardant payload container 311. The fuse selector 330 may move (i.e., rotate) in a first rotational direction (i.e., clockwise) or a second rotational direction (i.e., counterclockwise) in response to an application of force (e.g., pushing, pulling) thereto. The fuse selector 330 may be moved to select a fuse setting for the multi-option fuse 320. For example, the fuse selector 330 may select a type of the mortar shell (e.g., 60-mm), a time period for detonation, a time delay prior to detonation, and/or a time delay to detonation after reaching the target surface and/or the fire.

Each of the plurality of propellant charges 340 may include pyroxyline, but is not limited thereto. Also, the plurality of propellant charges 340 may be any type of propellant charge, such as M219 propelling charges, M204 propelling charges, and/or M230 propelling charges.

The plurality of propellant charges 340 may be disposed on at least a portion of an end of the tail cone 312. The plurality of propellant charges 340 may ignite and/or detonate in response to contacting a firing pin within a rifled barrel 10. The plurality of propellant charges 340 may adjust a trajectory, speed, and/or range of the main body 310 in response to being propelled from the rifled barrel 10. Moreover, a number of the plurality of propellant charges 340 may be adjusted (i.e., added, subtracted) to change the trajectory, the speed, and/or the range during firing.

The ignition unit 350 may include an ignition cartridge, a flash reducer, and a piston, but is not limited thereto. Also, the ignition cartridge of the ignition unit 350 may be any type of ignition cartridge, such as an M752A1 ignition cartridge.

The ignition unit 350 may be disposed at the end of the tail cone 312. The ignition unit 350 may ignite at least one of the plurality of propellant charges 340 in response to contact with the firing pin within the rifled barrel 10. In other words, the ignition unit 350 may facilitate ignition of at least one of the plurality of propellant charges 340. Also, the ignition unit 350 may ignite the plurality of propellant charges 340 to detonate the main body 310 to release the at least one fire retardant compound in response to receiving the detonation signal from the multi-option fuse 320. For example, the piston of the ignition unit 350 may strike at least one of the plurality of propellant charges 340.

The flash reducer of the ignition unit 350 may reduce a flash during propelling of the main body 310 from the rifled barrel 10.

The plurality of fins 360 may be disposed on at least a portion of the end of the tail cone 312 and/or the ignition unit 350. The plurality of fins 360 may extend away from a center of the ignition unit 350. Moreover, the plurality of fins 360 may stabilize movement of the main body 310 to ensure accuracy of the main body 310 during flight.

The primer plug 370 may be disposed at a center of the plurality of fins 360. The primer plug 370 may ignite the ignition unit 350 in response to contact with the firing pin of the rifled barrel 10.

The obturating ring 380 may be disposed between the fire retardant payload container 311 and/or the tail cone 312. The obturating ring 380 may seal a connection between the fire retardant payload container 311 and/or the tail cone 312. Thus, the obturating ring 380 may form a pressurized seal within the main body 310. As such, the obturating ring 312 may prevent the at least one fire retardant compound from leaking. However, the obturating ring 380 may rupture along an axis during detonation to ensure disbursement of the at least one fire retardant compound.

Therefore, the fire extinguishing mortar shell 300 may quickly extinguish a wildfire and/or a brushfire in response to detonating over the fire and resolve fire hazards at federal, state, local, and tribal levels. Also, the fire extinguishing mortar shell 300 may reduce complexity of managing the wildfire and/or the brushfire in difficult terrain.

The present general inventive concept may include a fire extinguishing mortar shell 100, including a main body 110 to store at least one compound therein, a fire retardant compound disposed within the main body 110 to eliminate a fire in response to contact with the fire, a multi-option fuse 120 disposed on at least a portion of the main body 110 to send a detonation signal therefrom in response to detecting the fire and a position of the main body 110 with respect to a target surface where the fire is located, and at least one propellant charge 140 disposed on at least a portion of the main body 110 to detonate the main body 110 to release the at least one fire retardant compound in response to receiving the detonation signal from the multi-option fuse 120.

The fire retardant compound may be at least one of huntite, hydromagnesite, aluminum hydroxide, and magnesium hydroxide.

The multi-option fuse 120 may monitor at least one of a position of the main body 110, an altitude of the main body 110, a temperature level of a surrounding environment of the main body 110, and a terrain of the surrounding environment.

The fire extinguishing mortar shell 100 may further include a fuse selector 130 movably disposed on at least a portion of the main body 110 to select a fuse setting for the multi-option fuse 120.

The fuse selector 130 may select at least one of a type of a mortar shell, a time period for detonation, a time delay prior to detonation, and a time delay to detonation after reaching the target surface.

The fire extinguishing mortar shell 100 may further include an ignition unit 150 disposed on at least a portion of the main body 110 to ignite the at least one propellant charge 140.

The fire extinguishing mortar shell 100 may further include a plurality of fins 160 disposed on at least a portion of the main body 110 to stabilize movement of the main body 110 during flight.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A fire extinguishing mortar shell, comprising:
a main body to store at least one compound therein;
a fire retardant compound disposed within the main body to eliminate a fire in response to contact with the fire;
a multi-option fuse disposed on at least a portion of the main body to send a detonation signal therefrom in response to detecting the fire and a position of the main body with respect to a target surface where the fire is located; and
at least one propellant charge disposed on at least a portion of the main body to detonate the main body to release the at least one fire retardant compound in response to receiving the detonation signal from the multi-option fuse.

2. The fire extinguishing mortar shell of claim 1, wherein the fire retardant compound is at least one of huntite, hydromagnesite, aluminum hydroxide, and magnesium hydroxide.

3. The fire extinguishing mortar shell of claim 1, wherein the multi-option fuse monitors at least one of a position of the main body, an altitude of the main body, a temperature level of a surrounding environment of the main body, and a terrain of the surrounding environment.

4. The fire extinguishing mortar shell of claim 1, further comprising:
a fuse selector movably disposed on at least a portion of the main body to select a fuse setting for the multi-option fuse.

5. The fire extinguishing mortar shell of claim 4, wherein the fuse selector selects at least one of a type of a mortar shell, a time period for detonation, a time delay prior to detonation, and a time delay to detonation after reaching the target surface.

6. The fire extinguishing mortar shell of claim 1, further comprising:
an ignition unit disposed on at least a portion of the main body to ignite the at least one propellant charge.

7. The fire extinguishing mortar shell of claim 1, further comprising:
a plurality of fins disposed on at least a portion of the main body to stabilize movement of the main body during flight.
